(19) United States
(12) Patent Application Publication
(10) Pub. No.: US 2002/0035696 A1
(43) Pub. Date: Mar. 21, 2002

(54) System and method for protecting a networked computer from viruses

(76) Inventor: Will Thacker, Grass Valley, CA (US)

Correspondence Address: FLEHR HOHBACH TEST, ALBRITTON & HERBERT LLP, Suite 3400, Four Embarcadero Center, San Francisco, CA, 94111-4187, US

(21) Appl. No.: 09/876,863

(22) Filed: Jun. 7, 2001

Related U.S. Application Data
(60) Provisional application No. 60/210,656, filed on Jun. 9, 2000.

(51) Int. Cl. G06F 11/30

(52) U.S. Cl. 713/200

(57) ABSTRACT

System and method in which a virus trap is connected between a computer and a network to prevent a virus from entering the computer from the network.

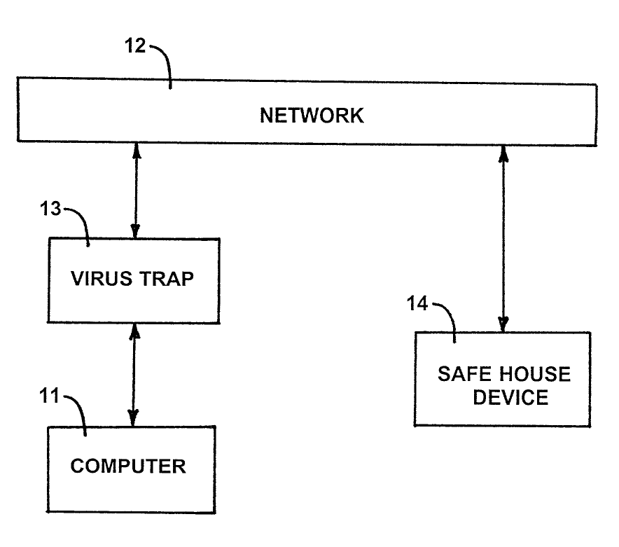

This is based on Provisional Application Serial No. 60/210,656, filed June 9, 2000.

This invention pertains generally to computers and viruses and, more particularly, to an active device and method which provide continuous virus protection for a networked computer, independent of the operating system, with special focus on email attachments and so-called worms.

In its simplest form, a computer virus is a stream of data that executes in a hostile way once it is inside a user's computer without the user being aware that his computer has been infected. These days a virus can be launched over the Internet and spread worldwide in a matter of hours.

Existing virus protection schemes can protect the end user only after a virus becomes known and information is gathered about the nature of the virus. Only then can the creators of anti-virus software build information about the new virus into their databases, which must then be deployed to the systems of the end users. Many end users suffer the effects of new viruses until they are understood and documented. Existing virus protection software detects virus patterns by comparing incoming data with patterns of data corresponding to the virus code, and virus detection takes place in target machines which may already have been infected. This requires far too much time and action on the part of the end user, and many times the protection is too late to prevent infection and subsequent virus deployment.

It is in general an object of the invention to provide a new and improved system and method for protecting computers from viruses.

Another object of the invention is to provide a system and method of the above character which effectively prevent viruses from entering a computer from a network to which the computer is connected.

These and other objects are achieved in accordance with the invention by providing a system and method in which a virus trap is connected between a computer and a network to prevent a virus from entering the computer from the network.

The single figure of drawings is a block diagram of one embodiment of a system incorporating the invention.

As illustrated in the drawing, the system comprises a computer 11 which is connected to the Internet or other network of computers 12, with a virus trap 13 connected between the computer and the network for preventing viruses from entering the computer from the network. A fully isolated test computer 14, sometimes referred to as a safe house device, is also connected to the network for testing programs which are downloaded intentionally. If desired, both the virus trap and the safe house device can be connected to the internal bus system of computer 11 and housed within that computer. In the case of a personal computer, for example, the virus trap and the safe house device can be connected to the PCI or ISA slots of the computer.

The virus trap acts both as a permissions gate and as a decoy, actively allowing no hostile attachments or files to pass without notice, especially the type of virus that is introduced as email attachments and then runs automatically or semi-automatically the user's system. A virus may even penetrate, run and destroy sacrificial data in the virus trap, but the virus trap includes failsafe technology which enables it to recover and report the incident to the user without affecting the operation of the user's real system.

The invention is applicable to a computer system with any type of processor. However, it is particularly applicable to the x86 family of processors (e.g. 286, 386, etc.). Due to the common logic of the x86 architecture, it should be possible to locate and detect any operating system execution and file access application programming interface (API). As an example, all execution type API's must at some point read the directory of a file storage device. On x86 CPS's there are only a few primitive levels where these events occur. The invention can trap these events when configured to run in the full Intel protected mode using its own operating system and firmware.

Because the virus trap is designed to trap executable programs and attachments, it needs no virus detection patterns, and thus requires no latebreaking virus recognition information from the virus protection industry. The device detects new viruses and therefore is not limited to the viruses which have already been documented in databases.

Users can select a by-pass for programs and attachments which are known to be good, and programs which are downloaded intentionally by the user can even be detected and sent to the fully isolated test machine illustrated as safe house device 14 in the drawing.

The virus trap can be made especially sensitive to detecting programs that attempt to automatically re-transmit through standard Internet email layers and pathways, thus helping to prevent the rapid and uncontrollable spread of viruses via the Internet.

The algorithms employed in the virus trap can be designed to focus on OS independent file erasure and rewriting attempts, and can employ the use of sacrificial data files.

If desired, the virus trap can be combined with existing pattern detection software to provide even greater protection against viruses.

It is apparent from the foregoing that a new and improved system and method for protecting computers from viruses have been provided. While only certain presently preferred embodiments have been described in detail, as will be apparent to those familiar with the art, certain changes and modifications can be made without departing from the scope of the invention as defined by the following claims.

1. A virus trap adapted to be connected between a computer and a network to prevent a virus from entering the computer from the network.

2. The virus trap of claim 1 wherein the virus trap includes means for intercepting incoming data that attempts to execute.

3. The virus trap of claim 1 wherein the virus trap comprises a computer virus trap which thwarts attempts to execute anything other than its own algorithms.

4. The virus trap of claim 1 wherein the virus trap includes means for detecting and trapping executable programs and email attachments.

5. The virus trap of claim 1 wherein the virus trap includes sacrificial data which can be destroyed by a virus from the network, and means for reporting the destruction of the data to the computer.

6. A system comprising a computer, a network, and a virus trap connected between the computer and the network to prevent a virus from entering the computer from the network.

7. The system of claim 6 wherein the virus trap includes means for intercepting incoming data that attempts to execute.

8. The system of claim 6 wherein the virus trap comprises a computer system which thwarts attempts to execute anything other than its own algorithms.

9. The system of claim 6 wherein the virus trap includes means for detecting and trapping executable programs and email attachments.

10. The system of claim 6 wherein the virus trap includes sacrificial data which can be destroyed by a virus from the network, and means for reporting the destruction of the data to the computer.

11. The system of claim 6 together with a separate computer connected to the network for testing executable programs which are intentionally downloaded from the network.

12. In a method of protecting a computer against viruses from a network, the step of: connecting a virus trap between the computer and the network to prevent a virus from entering the computer from the network.

13. The method of claim 12 wherein the virus trap intercepts incorming data that attempts to execute.

14. The method of claim 12 wherein the virus trap comprises a computer system which thwarts attempts to execute anything other than its own algorithms.

15. The method of claim 12 wherein the virus trap detects and traps executable programs and email attachments.

16. The method of claim 12 wherein the virus trap allows sacrificial data which to be destroyed by a virus from the network, and then reports the destruction of the data to the computer.

17. The method of claim 12 further including the steps of connecting a separate computer to the network, and testing executable programs which are intentionally downloaded from the network in the separate computer.
